(19) United States
(12) Patent Application Publication
(10) Pub. No.: US 2011/0144269 A1
(43) Pub. Date: Jun. 16, 2011

(54) DISPERSING AGENT AND ITS USE

(75) Inventors: Dirk Kuppert, Aschaffenburg (DE); Thomas Veit, Hagen (DE); Philippe Favresse, Ratingen (DE); Beatrix Andrea vom Bruch, Bochum (DE); Wolfgang Mueller, Essen (DE); Mario Loebbus, Mulheim an der Ruhr (DE)

(73) Assignee: EVONIK GOLDSCHMIDT GMBH, Essen (DE)

(21) Appl. No.: 13/058,372

(22) PCT Filed: Jul. 16, 2009
(86) PCT No.: PCT/EP2009/059136

§ 371 Date: Feb. 10, 2011

(30) Foreign Application Priority Data
Aug. 11, 2008 (DE) 10 2008 41 139.6

(51) Int. Cl. C08L 39/00; C08F 220/34

(52) U.S. Cl. 524/555; 526/312

(57) ABSTRACT

The invention relates to block copolymers of the formula E-[AB]-T, where E is an initiator fragment of a polymerization initiator capable of initiating a free-radical atom-transfer polymerization reaction, A and B are differently structured polymer blocks, and T is a chain-polymer-termination group, and also to production of these and use as dispersing agent.

The invention relates to block copolymers, more particularly those suitable for use as dispersants, especially in paints and varnishes.

In the production of paints, varnishes, printing inks, and other coating materials, dispersants facilitate the incorporation of solids, such as fillers and pigments, for example, which, as important formulating ingredients, substantially determine the visual appearance and the physicochemical properties of systems of this kind. For optimum utilization, these solids must be dispersed uniformly in the formulations, and the dispersion, once achieved, must be stabilized.

A multiplicity of different substances are nowadays used as dispersants for solids. In addition to very simple compounds of low molecular weight, such as lecithin, fatty acids and their salts, and alkylphenol ethoxylates, for example, polymers, too are used as dispersants.

The use of such products, however, is also frequently associated with a multiplicity of disadvantages: On use in pigment pastes, high levels of dispersing additives are often necessary; the levels of paste pigmentation that can be achieved are unsatisfactorily low; the stability of the pastes and hence the consistency of their viscosity is inadequate; and flocculation and aggregation are not always avoidable. In many cases, there is a lack of shade consistency following storage of the pastes, and a lack of compatibility with diverse binders.

The use of known dispersing additives in many cases also adversely affects the water resistance or light stability of coating materials, and, in addition, the unwanted foam that is formed in the course of preparation and processing is stabilized.

There is therefore a growing need for dispersants for solids that exhibit further-improved properties relative to the prior art. The requirement, for example, is for dispersants which achieve a maximum stabilizing action on a multiplicity of different solids and/or achieve improved depth of shade of the pigments in the coating material.

WO 01/44389 describes pigment dispersions with as dispersant a polymer compound which is obtainable by controlled radical polymerization and has the formula X-(G)ₚ-(E)ₛ-T, where G is a moiety of a radically polymerizable ethylenically unsaturated monomer, E is a hydrophilic moiety of a radically polymerizable ethylenically unsaturated monomer, E and G being different, X is a hydrophobic radical originating from the initiator used, and T is a radical transfer group originating from the initiator used, and p and s are selected such that the average molecular weight is at least 250 g/mol.

U.S. Pat. No. 7,199,177 describes a pigment composition containing from 0.1% to 99.9% by weight of a block copolymer of the formula X-[Gₚ-Eₛ]_{b}-T_{c}, where G is a polymer block of repeating units of (meth)acrylic acid C₁-C₂₄ alkyl esters, E is a polymer block of repeating units of (meth)acrylic acid C₁-C₂₄ alkyl esters which are copolymerized with at least 50% by weight of monomers which carry functional groups, X is a radical originating from the initiator used, T is a polymer chain end group, and c, p, and s are each >0.

WO 00/40630 describes compositions comprising as dispersants compounds of the formula Xₐ-[Aₓ-B_{y}]-T_{c}, where X is an initiator fragment, A and B are polymer blocks with different polarities, and x and y indicate the number of monomer units in each of the blocks, and T represents a chain polymer termination group. The dispersants described in WO 00/40630 are obtained by atom transfer radical polymerization (ATRP).

Atom transfer radical polymerization (ATRP) represents a versatile process for preparing a multiplicity of polymers and copolymers such as, for example, polyacrylates, polymethacrylates, polystyrenes or copolymers. The ATRP method was developed in the 1990s by Prof. Matyjaszewski, and is described in references including J. Am. Chem. Soc., 1995, 117, p. 5614 and WO 97/18247. A particular advantage of ATRP is that not only the molecular weight but also the molecular weight distribution can be regulated. As a living polymerization, furthermore, it allows the controlled construction of polymer architectures such as, for example, random copolymers or else block copolymer structures. Through corresponding initiators, for example, unusual block copolymers and star polymers are additionally obtainable. Theoretical principles of the polymerization mechanism are elucidated in references including Hans Georg Elias, Makromolekule, volume 1, 6^{th} edition, Weinheim 1999, p. 344.

The ATRP process is based on a redox equilibrium between the growing radical polymer chain, which is present only at a low concentration, and a transition metal compound in a higher oxidation state (e.g., copper II), and the dormant, preferential combination of the polymer chain terminated with a halogen or pseudohalogen, and the corresponding transition metal compound in lower oxidation state (e.g., copper I). This is true not only of ATRP in the actual form, which is initiated with correspondingly (pseudo-)halogen-substituted initiators, but also of reverse ATRP, in which the halogen is attached to the polymer chain only when the equilibrium is established.

Irrespective of the process selected, after termination of the reaction, the halogen atom always remains at the respective chain ends. The presence of this organically bonded halogen, and particularly of the organically attached bromine, however, is disadvantageous for the use of polymers prepared by the ATRP method, since such compounds can lead to allergies and, furthermore, are poorly metabolized by the body and tend to accumulate in the fatty tissue.

The transition metal compounds used in ATRP, and especially the Cu compounds that are used in the great majority of the polymer syntheses, are likewise disadvantageous, since copper, even at low concentrations, leads to strongly colored products. Furthermore, copper compounds may be irritant and sensitizing on contact with the skin.

A simple and efficient method for removing the terminal halogen atoms and the transition metal compound is therefore of great interest. Particularly desirable are methods in which both are achieved in a simultaneous process step, in order to make the purification of the polymers as efficient and cost-effective as possible.

One of the patents describing methods for removing transition metal compounds from polymers or polymer solutions is DE 10 2006 015 846. DE 10 2006 015 846 describes a method for removing transition metal compounds from polymer solutions, characterized in that the transition metal compound is precipitated by addition of a sulfur-containing precipitant, such as a mercaptan or a compound having a thio group, for example, and is removed by filtration. The content of the cited document is referred to expressly, and the content of the cited documents is considered part of the disclosure content of the present specification.

Methods for removing the terminal halogen atoms are described in locations including the following:

US 2005/0900632 discloses a process for the substitution of the halogens by means of metal alkoxides, with precipitation of the metal halide formed. Disadvantages of this procedure, however, are the limited availability of the metal alkoxides, the costs thereof, and the fact that the process can be carried out only after purification of the polymers.

WO 00/34345 and Heuts et al. (Macromol. Chem. Phys., 1999, 200, pp. 1380-1385) describe the implementation of ATRP with initial addition of sulfur compounds (n-dodecyl mercaptan and octyl mercaptan, respectively). In both cases, thermally more stable polymers that are probably halogen-free are described; in both cases, however, it is also noted that the width of the molecular weight distribution is greater than 1.6 and is therefore very similar to that of a free-radically polymerized material. The ATRP advantages of products with narrow distribution and of control over the polymer architecture are therefore no longer available. The procedure described, moreover, does not refer to precipitation of the transition metal compounds.

WO 2005/098415 describes the substitution of the terminal halogen atoms in polystyrenes, which is, in turn, polymer-analogous—that is, carried out after the purification of the polymer. Here, substitution takes place exclusively only at one chain end, with thiourea and with subsequent quenching with sodium hydroxide to form sodium sulfide groups. Disadvantages, in addition to the two-stage procedure, are the unilateral substitution, and also the implementation of the reaction after the polymer has been purified.

WO 2008/017523 discloses a process for removing halogen atoms from polymers and separating off transition metal compounds, characterized in that the halogen atoms are substituted by addition of a suitable sulfur compound, as for example a mercaptan or an organic compound having a thio group, and simultaneously the transition metal compound is precipitated by this sulfur compound and subsequently separated off by filtration.

On the basis of the known prior art, an object of the present invention was to provide alternative dispersants which preferably permit improved dispersing of pigments, and also to provide improved processes for preparing these dispersing additives.

Surprisingly it has been found that this object is achieved by means of block polymers as claimed in claim 1.

The present invention accordingly provides block copolymers as claimed in claim 1, a process for preparing them, compositions which comprise these block copolymers, especially as dispersants, and the use of these compositions, as described in the claims.

The block copolymers of the invention have the advantage that they possess only a low (<5 ppm by mass) fraction of terminally bonded bromine and when used in coating formulations result in improved depth of shade.

The block copolymers of the invention, a process for preparing them, and their use are described by way of example below, without any intention that the invention should be confined to these exemplary embodiments. Where ranges, general formulae or classes of compound are indicated below, they should be taken to include not only the corresponding ranges or groups of compounds that are mentioned explicitly, but also all subranges and subgroups of compounds that may be obtained by extraction of individual values (ranges) or compounds. Where documents are cited in the context of the present description, the intention is that their content should belong in its entirety to the disclosure content of the present invention.

The block copolymers of the invention, of the formula E-[AB]-T, where E is an initiator fragment of a polymerization initiator which is capable of initiating an atom transfer radical polymerization, A and B are different polymer blocks, and T is a chain polymer termination group, are distinguished by the fact that the polymer block A is built from monomers of the formula A1:

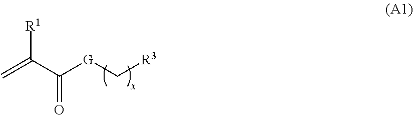

and the polymer block B is formed by a copolymer of monomers of the formula B1:

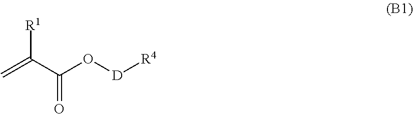

where D is a divalent radical of the general formula (C1)

—(C₂H₄O)ᵢ(C₃H₆O)ⱼ(C₄H₈O)ₖ(C₁₂H₂₄O)ₗ(C₈H₈O)ₘ— (C1)

where i, j, k, l, and m are mutually independent integers from 0-100, with the proviso that the sum of i+j+k+l+m≧1, and, if more than one of the indices i, j, k, l, and m is >0, the general formula (C1) represents a random oligomer, a block oligomer or a gradient oligomer,
and monomers of the formula B2:

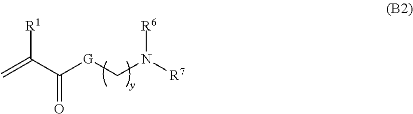

where R¹ independently at each occurrence is H or alkyl, preferably methyl,
G=oxygen or NR², where R² independently at each occurrence is H or alkyl having 1 to 8 C atoms, preferably G=oxygen. In the case of G=NR², R² is preferably H; R³ is aryl or arylalkyl radical, preferably phenyl or naphthyl radical, more preferably phenyl radical, R⁴ is alkyl, preferably C₁ to C₃ alkyl, more preferably methyl, R⁶ and R⁷ independently of one another are alkyl radicals, preferably C₁ to C₃ alkyl, more preferably methyl, x=0 to 10, preferably 1 to 4, more preferably 1, and y is 1 to 10, preferably 1 to 4, more preferably 2.

In the formula (C1) the index i is preferably greater than 0, more preferably from 10 to 15. With particular preference the indices i and j are greater than 0.

The polymer chain termination group T is preferably a sulfur-containing radical —SQ where Q is a monovalent organic radical, which is preferably an alkyl radical, an alcohol radical or an acid radical, more preferably having 1 to 20 carbon atoms. With particular preference the group T is a radical obtained by eliminating a hydrogen atom (the acidic hydrogen) from the compounds of the group encompassing thioglycolacetic acid, mercaptopropionic acid, mercaptoethanol, mercaptopropanol, mercaptobutanol, mercaptohexanol, octyl thioglycolate, methyl mercaptan, ethyl mercaptan, butyl mercaptan, dodecyl mercaptan, isooctyl mercaptan, and tert-dodecyl mercaptan, it being possible for these compounds to be unsubstituted or substituted; preferably, however, they are unsubstituted.

In the block copolymer of the invention, the polymer block A preferably has a number-average molecular weight of 500 g/mol to 100 000 g/mol. The polymer block B preferably has a number-average molecular weight of 1000 g/mol to 200 000 g/mol, more preferably a number-average molecular weight of 5000 g/mol to 100 000 g/mol, and very preferably of 5000 g/mol to 75 000 g/mol. Particularly preferred block copolymers are those in which both the polymer block A and the polymer block B have a molecular weight within the preferred range.

The block copolymer of the invention preferably has a number-average molecular weight of 1500 g/mol to 500 000 g/mol, more preferably of 5000 g/mol to 100 000 g/mol, and very preferably of 10 000 g/mol to 75 000 g/mol.

The block copolymer of the invention contains preferably less than 5 ppm by mass, more preferably less than 2 ppm by mass, of organically bonded, more particularly of terminal, halogen, more particularly bromine. With particular preference the block copolymer contains no organically bonded halogen or at least only undetectable amounts of organically bonded halogen.

The block copolymers of the invention can be prepared in a variety of ways. The block copolymers of the invention are preferably obtainable by the process described below.

The process of the invention for preparing the block copolymers of the invention is distinguished by the fact that it comprises the steps of

A) reacting an atom transfer radical initiator, of the formula EX, having at least one organically bonded halogen atom X, with monomers of the formula A1 in the presence of at least one transition metal-containing catalyst, in a polymerization step,
B) reacting the compounds obtained in step A) with the compounds B1 and B2, and
C) adding a compound TH to the polymerization mixture from step B),
where A, B, B1, B2, and T have the definition described above.

Use is made as compound TH preferably of thioglycolacetic acid, mercaptopropionic acid, mercaptoethanol, mercaptopropanol, mercaptobutanol, mercaptohexanol, octyl thioglycolate, methyl mercaptan, ethyl mercaptan, butyl mercaptan, dodecyl mercaptan, isooctyl mercaptan or tert-dodecyl mercaptan.

As initiator EX it is possible to make use of any compound which has an atom or a group of atoms which can be transferred radically under the polymerization conditions of the ATRP process. Preference is given to using p-toluenesulfonyl chloride, 2-chloro- or 2-bromopropionic acid, 2-chloro- or 2-bromoisobutyric acid, 1-phenethyl chloride or bromide, methyl or ethyl 2-bromo- or 2-chloropropionate, ethyl or methyl 2-chloro- or 2-bromoisobutyrate, chloro- or bromoacetonitrile, 2-chloro- or 2-bromopropionitrile, α-bromo-benzacetonitrile or α-bromo-γ-butyrolactone.

As monomers A1, B1, and B2, the monomers stated above can be used. As monomers of the formula A1 it is preferred to use benzyl acrylate or methacrylate, more preferably benzyl methacrylate.

As monomers of the formula B1 it is preferred to use methylpolyethylene glycol methacrylates, preferably having 10 to 15, more preferably having 11 to 13, ethylene oxide units. As monomers of the formula B2 it is preferred to use dimethylaminoalkyl methacrylate, where alkyl=methyl, ethyl, propyl or butyl, preferably methyl.

Process steps A) and B) can be carried out as ATRP.

Suitable transition metal-containing catalysts for process steps A) and B) are, for example, those transition metal compounds as described in more detail in, for example, Chem. Rev. 2001, 101, p. 2921 ff., expressly incorporated by reference. Generally speaking, it is possible to use any transition metal compounds which are able to form a redox cycle with the initiator, or with the polymer chain containing a transferable group of atoms—a halogen, for example. Catalysts used with preference are selected from the compounds of copper, iron, cobalt, chromium, manganese, molybdenum, silver, zinc, palladium, rhodium, platinum, ruthenium, iridium, ytterbium, samarium, rhenium and/or nickel, more particularly those in which the transition metal is present in oxidation state I. Copper compounds are used with preference. As copper compounds it is preferred to use those selected from Cu₂O, CuBr, CuCl, CuI, CuN₃, CuSCN, CuCN, CuNO₂, CuNO₃, CuBF₄, Cu(CH₃COO) or Cu(CF₃COO), and mixtures thereof.

Alternatively to the implementation of process steps A) and B) as ATRP, they may also be carried out as what is called reverse ATRP. In this variant of the process, transition metal compounds in higher oxidation states can be used, such as CuBr₂, CuCl₂, CuO, CrCl₃, Fe₂O₃ or FeBr₃, for example. In these cases, the reaction can be initiated by means of conventional free-radical initiators such as AIBN, for example. The transition metal compounds here are initially reduced, since they are reacted with the radicals generated from the conventional free-radical initiators. Reverse ATRP has been described by authors including Wang and Matyjaszewski in Macromolecules, 1995, 28, p. 7572 ff., expressly incorporated by reference.

One variant of reverse ATRP represents the additional use of metals in the oxidation state zero. Through an assumed comproportionation with the transition metal compounds at the higher oxidation state, the rate of reaction is accelerated. This process is described in more detail in WO 98/40415, expressly incorporated by reference.

Further variants of ATRP include, for example, the AGET method (activator generated by electron transfer), the ICAR method (initiator for continuous activator regeneration), and the ARGET method (activators regenerated by electron transfer). A comprehensive description of these variants is found in T. Pintauer & K. Matyjaszewski, Chem. Soc. Rev., 2008, 37, pages 1087-1097.

In order to increase the solubility of the metal compounds in the reaction solution and at the same time to prevent the formation of stable organometallic compounds which as a result are inactive in polymerization, it may be advantageous to add ligands to the reaction mixture. Additionally, through the addition of ligands, it is possible to facilitate the abstraction of the transferable group of atoms by the transition metal compound. A listing of suitable ligands is found in WO 97/18247, WO 97/47661 or WO 98/40415, for example. The compounds used as ligands preferably contain usually one or more nitrogen, oxygen, phosphorus and/or sulfur atoms as a coordinative constituent. Particular preference is given in this context to nitrogen-containing compounds. Especially preferred are nitrogen-containing chelate ligands. Examples of particularly suitable ligands are, for example, 2,2′-bipyridine, N,N,N′,N″,N″-pentamethyl-diethylenetriamine (PMDETA), tris(2-aminoethyl)amine (TREN), N,N,N′N′-tetramethylethylenediamine or 1,1,4,7,10,10-hexamethyltriethylenetetramine. For the skilled person it is obvious that a multiplicity of further ligands may likewise be used.

These ligands may form coordination compounds with the metal compounds in situ, or they may first be prepared as coordination compounds and then added to the reaction mixture.

The ratio of ligand to transition metal is dependent on the denticity of the ligand and on the coordination number of the transition metal. In process step A) the amount of ligand used is preferably such that the molar ratio of ligand to transition metal is from 100:1 to 0.1:1, preferably 6:1 to 0.1:1, and more preferably 3:1 to 1:1.

The polymerization in steps A) and B) may take place in bulk or in solution. The polymerization in steps A) and B) may be carried out as an emulsion polymerization, miniemulsion or microemulsion polymerization or suspension polymerization.

Where steps A) and B) are carried out in the presence of a solvent, it is preferred to use halogen-free solvents, more preferably toluene, xylene, acetates, preferably butyl acetate, ethyl acetate, propyl acetate; ketones, preferably ethyl methyl ketone, acetone; ethers; aliphatics, preferably pentane, hexane; or alcohols, preferably cyclohexanol, butanol, hexanol. Water or mixtures of water and water-miscible solvents may also be suitable solvents.

The polymerization in steps A) and B) may be carried out under atmospheric pressure, subatmospheric or superatmospheric pressure, preferably under atmospheric pressure. The polymerization is carried out preferably in a temperature range from −20° C. to 200° C., more preferably from 0° C. to 130° C., very preferably from 30° C. to 120° C.

The termination of the polymerization in steps A) and B) may take place, for example, in a way known to the skilled person, by oxidation of the transition metal. This can be accomplished, for example, by introducing oxygen into the polymerization mixture, such as by passing air through it, for example.

Step C) may see the sulfur compound TH (Q-SH) added to the polymerization mixture from step B), as for example after or during the termination of the polymerization reaction. The compound TH may be added directly or else a suitable compound may be added from which a compound TH is obtained or released.

The addition of the sulfur compound TH may be made directly to the polymerization mixture obtained in polymerization step B), or else to a worked-up polymerization mixture. Preferably the addition is made directly to the polymerization mixture obtained in process step B), without prior workup.

The sulfur compound TH is used only in a minimal excess, based on the chain ends (organically bonded halogen) of 1.6 equivalents, preferably 1.2 equivalents, and more preferably from 1 to 1.1 equivalents. As a result of the addition of the mercapto-functionalized sulfur compound, there is removal of the terminal halogen atoms, presumably by substitution thereof. Furthermore, in the same step, the transition metal compound is precipitated in such a way that it can be removed from the polymer solution in a simple filtration. This minimal excess also results in only a very low residual sulfur content of the polymer solution, one which is readily removable by modification of the subsequent filtration step, by the addition, for example, of adsorbents such as activated carbon to the mixture, or by the use as filter material of an activated carbon filter.

As a result of the at least equivalent addition of sulfur compounds TH it is possible to obtain the block copolymers of the invention, which are halogen-free or virtually halogen-free. With this step, moreover, it is possible to ensure that block copolymers with terminal thioether groups having a copper content <5 ppm by mass, more preferably <2 ppm by mass, can be obtained.

The sulfur compounds TH may contain one or more SH groups. In the process of the invention it is preferred, as sulfur compounds Q-SH, to make use of thioglycolacetic acid, mercaptopropionic acid, mercaptoethanol, mercaptopropanol, mercaptobutanol, mercaptohexanol, octyl thioglycolate, methyl mercaptan, ethyl mercaptan, butyl mercaptan, dodecyl mercaptan, isooctyl mercaptan or tert-dodecyl mercaptan.

The skilled worker readily realizes that the sulfur compounds described, on addition to the polymer solution after the end of the polymerization, apart from the described substitution reaction of the terminal halogen atoms, will have no further influence on the polymers. This is true in particular in respect of the molecular weight distributions, the number-average molecular weight of the units A and B, additional functionalities, glass transition temperatures, or melting temperatures in the case of semicrystalline polymers, and polymer architectures such as branching systems or block structures.

The block copolymers of the invention may be used more particularly as dispersants.

Particularly preferred compositions are therefore those compositions which comprise block copolymers of the invention as dispersants, preferably as sole dispersant. In addition to the dispersant, the composition may comprise water and, possibly, further ingredients, or may be composed of water and dispersant, more particularly exclusively block copolymers of the invention, particularly if it is a dispersant composition. As further ingredients possibly present, the composition of the invention may comprise solids—for example, a pigment or two or more pigments.

A solid for the purposes of the present invention may in principle be any solid organic or inorganic material.

Examples of such solids are pigments, fillers, dyes, optical brighteners, ceramic materials, magnetic materials, nanodisperse solids, metals, biocides, agrochemicals, and drugs, which are employed as dispersions.

Preferred solids are pigments as specified, for example, in the “Colour Index, Third Edition, Volume 3; The Society of Dyers and Colorists (1982)” and in the subsequent revised editions.

Examples of pigments are inorganic pigments, such as carbon blacks, titanium dioxides, zinc oxides, Prussian blue, iron oxides, cadmium sulfides, chromium pigments, such as, for example, chromates, molybdates, and mixed chromates and sulfates of lead, zinc, barium, calcium, and mixtures thereof. Further examples of inorganic pigments are given in the book “H. Endriss, Aktuelle anorganische Bunt-Pigmente, Vincentz Verlag, Hannover (1997)”.

Examples of organic pigments are those from the group of the azo, diazo, condensed azo, naphthol, metal complex, thioindigo, indanthrone, isoindanthrone, anthanthrone, anthraquinone, isodibenzanthrone, triphendioxazine, quinacridone, perylene, diketopyrrolopyrrole, and phthalocyanine pigments. Further examples of organic pigments are stated in the book “W. Herbst, K. Hunger, Industrial Organic Pigments, VCH, Weinheim (1993)”.

Other preferred solids are fillers, such as, for example, talc, kaolin, silicas, barites, and lime; ceramic materials, such as, for example, aluminum oxides, silicates, zirconium oxides, titanium oxides, boron nitrides, silicon nitrides, boron carbides, mixed silicon-aluminum nitrides, and metal titanates; magnetic materials, such as, for example, magnetic oxides of transition metals, such as iron oxides, cobalt doped iron oxides, and ferrites; metals, such as, for example, iron, nickel, cobalt, and their alloys; and biocides, agrochemicals, and drugs, such as fungicides, for example.

The composition of the invention can be used for producing paints and varnishes.

In the examples set out hereinbelow, the present invention is described by way of example, without any intention that the invention, whose breadth of application is evident from the entire description and the claims, should be confined to the embodiments stated in the examples.

### EXAMPLE 1

A three-necked flask equipped with stirrer, thermometer, reflux condenser, nitrogen introduction tube, and dropping funnel was charged under an N₂ atmosphere with 46.57 g of benzyl methacrylate, 150 g of butyl acetate, 1.25 g of copper(I) oxide, and 3.2 g of PMDETA (N,N,N′,N″,N″-pentamethyldiethylenetriamine). The solution was heated to 90° C. Subsequently, at the same temperature, 3.2 g of ethyl bromoisobutyrate were added. After a reaction time of 2 hours, a mixture of 20.77 g of dimethylaminoethyl methacrylate (DMAEMA) and 75.06 g of methoxypolyethylene glycol 500 methacrylate (MPEG 500 MA from Evonik Röhm GmbH, CAS No.: [26915-72-0]) was added, and stirring was continued at 90° C. for 3 hours more. This was followed by a further hour of stirring, at 100° C. To terminate the reaction, atmospheric oxygen was introduced for approximately 15 minutes, and 3.22 g of n-dodecyl mercaptan were added. After an hour of stirring, the precipitate was filtered off by means of superatmospheric pressure filtration, through a filter from Beko (type: KD-10). On a rotary evaporator, the solvent was stripped from the light yellow filtrate at a temperature of 100° C. and at 2 mbar. The light yellow, viscous residue is the desired product.

### EXAMPLE 2

A three-necked flask equipped with stirrer, thermometer, reflux condenser, nitrogen introduction tube, and dropping funnel was charged under an N₂ atmosphere with 20.02 g of benzyl methacrylate, 150 g of butyl acetate, 1.1 g of copper(I) oxide, and 2.7 g of PMDETA (N,N,N′,N″,N″-pentamethyldiethylenetriamine). The solution was heated to 90° C. Subsequently, at the same temperature, 2.7 g of ethyl bromoisobutyrate were added. After a reaction time of 2 hours, a mixture of 26.75 g of dimethylaminoethyl methacrylate (DMAEMA) and 96.66 g of methoxypolyethylene glycol 500 methacrylate (MPEG 500 MA from Evonik Röhm GmbH, CAS No.: [26915-72-0]) was added, and stirring was continued at 90° C. for 3 hours more. This was followed by a further hour of stirring, at 100° C. To terminate the reaction, atmospheric oxygen was introduced for approximately 15 minutes, and 2.8 g of n-dodecyl mercaptan were added. After an hour of stirring, the precipitate was filtered off by means of superatmospheric pressure filtration, through a filter from Beko (type: KD-10). On a rotary evaporator, the solvent was stripped from the light yellow filtrate at a temperature of 100° C. and at 2 mbar. The light yellow, viscous residue is the desired product.

### EXAMPLE 3

A three-necked flask equipped with stirrer, thermometer, reflux condenser, nitrogen introduction tube, and dropping funnel was charged under an N₂ atmosphere with 20.47 g of benzyl methacrylate, 150 g of butyl acetate, 0.55 g of copper(I) oxide, and 1.40 g of PMDETA (N,N,N′,N″,N″-pentamethyldiethylenetriamine). The solution was heated to 90° C. Subsequently, at the same temperature, 1.40 g of ethyl bromoisobutyrate were added. After a reaction time of 2 hours, a mixture of 20.47 g of dimethylaminoethyl methacrylate (DMAEMA) and 98.83 g of methoxypolyethylene glycol 500 methacrylate (MPEG 500 MA from Evonik Röhm GmbH, CAS No.: [26915-72-0]) was added, and stirring was continued at 90° C. for 3 hours more. This was followed by a further hour of stirring, at 100° C. To terminate the reaction, atmospheric oxygen was introduced for approximately 15 minutes, and 1.42 g of n-dodecyl mercaptan were added. After an hour of stirring, the precipitate was filtered off by means of superatmospheric pressure filtration, through a filter from Beko (type: KD-10). On a rotary evaporator, the solvent was stripped from the light yellow filtrate at a temperature of 100° C. and at 2 mbar. The light yellow, viscous residue is the desired product.

### EXAMPLE 4

A three-necked flask equipped with stirrer, thermometer, reflux condenser, nitrogen introduction tube, and dropping funnel was charged under an N₂ atmosphere with 9.50 g of benzyl methacrylate, 150 g of butyl acetate, 0.74 g of copper(I) oxide, and 1.87 g of PMDETA (N,N,N′,N″,N″-pentamethyldiethylenetriamine). The solution was heated to 90° C. Subsequently, at the same temperature, 1.87 g of ethyl bromoisobutyrate were added. After a reaction time of 2 hours, a mixture of 29.49 g of dimethylaminoethyl methacrylate (DMAEMA) and 106.54 g of methoxypolyethylene glycol 500 methacrylate (MPEG 500 MA from Evonik Röhm GmbH, CAS No.: [26915-72-0]) was added, and stirring was continued at 90° C. for 3 hours more. This was followed by a further hour of stirring, at 100° C. To terminate the reaction, atmospheric oxygen was introduced for approximately 15 minutes, and 1.90 g of n-dodecyl mercaptan were added. After an hour of stirring, the precipitate was filtered off by means of superatmospheric pressure filtration, through a filter from Beko (type: KD-10). On a rotary evaporator, the solvent was stripped from the light yellow filtrate at a temperature of 100° C. and at 2 mbar. The light yellow, viscous residue is the desired product.

### Performance Testing:

### Test Pigments:

From the multiplicity of possible solids, the following commercial pigments were selected: Printex® 95 (manufacturer: Evonik Industries AG) as carbon black pigment, Heliogenblau L7101F (manufacturer: BASF AG), Bayferrox® 120M and Bayferrox® 3920 (manufacturer: Bayer AG) as typical color pigments.

### White Tint:

For producing the paints, a white tint with the following composition is used:

TABLE 1
a) preparation of a white paste

| | Initial mass [g] |
|---|---|
| TD755W^{a)} | 17.4 |
| demineralized water | 39.6 |
| Foamex ® 810^{b)} | 2.0 |
| Parmetol ® K 40^{c)} | 0.2 |
| Aerosil ® 200^{d)} | 0.6 |
| Kronos ® 2310^{e)} | 140.0 |
| Total | 200.0 |

^{a)}dispersing additive, trade name of Evonik Industries AG
^{b)}defoamer, trade name of Evonik Industries AG
^{c)}biocide, trade name of Schülke & Mayr
^{d)}SiO₂, trade name of Evonik Industries AG
^{e)}titanium dioxide, trade name of KRONOS International, Inc.

The ingredients of the formula are admixed, in accordance with the above formula from Table 1, with 200 g of glass beads, and then shaken in a Skandex mixer (type: DAS H 200-K from Lau GmbH) for 2 hours. The glass beads are subsequently separated from the white paste by means of a sieve.

TABLE 2
b) Preparation of the white paint

| | Initial mass [g] |
|---|---|
| White paste (as per Table 1) | 45.0 |
| Neocryl XK | 53.5 |
| 90/Texanol ® 97:3^{f)} | |
| Tego ® Wet KL 245^{g)} | 0.5 |
| Visko Plus ® 3000^{h)} | 1.0 |
| Total | 100.0 |

^{f)}binder, trade name of NeoResins
^{g)}wetting agent, trade name of Evonik Industries AG
^{h)}thickener, trade name of Evonik Industries AG

The formulation is stirred at moderate shear rate with a dissolver for 15 minutes and then sieved through a 125 μm sieve.

### Preparation of the Pigment Pastes:

TABLE 3

| | Heliogenblau ® | | Printex ® | | Bayferrox ® | | Bayferrox ® | |
|---|---|---|---|---|---|---|---|---|
| | L7101F | | 95 | | 120M | | 3920 | |
| H₂O, | 50.0 | g | 67.0 | g | 23.2 | g | 38.5 | g |
| demin. | | | | | | | | |
| Dispersing | 14.0 | g | 12.0 | g | 7.8 | g | 10.5 | g |
| additive^{a)} | | | | | | | | |
| Foamex | 1.00 | g | 1.00 | g | 1.00 | g | 1.00 | g |
| 830^{b)} | | | | | | | | |
| Pigment | 35.0 | g | 20.0 | g | 65 | g | 50 | g |
| Sum total | 100 | g | 100 | g | 100 | g | 100 | g |

^{a)}copolymers from Examples 1-4, and amount of dispersing additive based on a 100% product.
^{b)}Defoamer, trade name of Evonik Goldschmidt GmbH

The formula ingredients are weighed out in accordance with the formulas above, from Table 3, into 250 ml screw-top glass vessels, and glass beads are added (200 g of glass beads to 100 g of millbase). The closed glass vessels are then shaken in a Skandex mixer (type: DAS H 200-K from Lau GmbH) for 2 hours. The glass beads are subsequently separated from the pigment paste by means of a sieve.

For testing, 1 g of each pigment paste and 20 g of white tint are weighed out jointly. The mixture is homogenized for 1 minute at 2500 rpm in a Speedmixer (type: DAC 150 FVZ from Hauschild & Co. KG). The tinted paints were applied using a spiral bar (100 μm) to a contrast chart (Leneta®) and dried at room temperature.

### Colorimetry:

Colorimetry on the paint blend (100 μm film thickness on Leneta® contrast chart) took place using an instrument from the company X-Rite (type: X-Rite SP 60). For all samples the L*a*b* values were determined in accordance with the CIE-Lab system (CIE=Commission Internationale de l'Eclairage). The CIE-Lab system is useful, as a three-dimensional system, for the quantitative description of the color loci. Plotted in the system on one axis are the colors green (negative a values) and red (positive a* values), and, on the axis at right angles to this, the colors blue (negative b* values) and yellow (positive b* values). The value C* is made up of a* and b* as follows: C*=(a*²+b*²) 0.5 and is used to describe violet color loci. The two axes intersect at the achromatic point. The vertical axis (achromatic axis) is relevant for the lightness, from white (L=100) to black (L=0). Using the CIE-Lab system it is possible to describe not only color loci but also color spacings, by stating the three coordinates.

The tristimulus value Y was determined in accordance with the following formula (Y1):

$$Y = {( \frac{{L}^{*} + 16}{116} )}^{3} * 100 \qquad ( Y1 )$$

The color strength F was determined in accordance with the following formula (Y2):

$$F = \frac{{( 100 - Y )}^{2}}{2 * Y} \qquad ( Y2 )$$

### Rub-Out Test:

In order to make visible and measurable the vertical floating, in particular, of pigments in coating films, the test known as the rub-out test can be carried out. For this test, the coating film still wet but having already started to set, is rubbed with the finger or with a brush. If the pigments have undergone separation or are in a highly flocculated state, the mechanical operation of rubbing forces them back into homogeneous distribution. The target shade of the homogeneous mixture is produced. The extent of the disruption is evident from the color difference relative to the unrubbed film. Both a positive and a negative rub-out effect may be obtained. A positive rub-out effect means that the color strength of the unrubbed film is lower than that of the rubbed film, which may be attributable, for example, to the floating of white pigment. In the case of a negative rub-out effect, the converse is the case.

Prior-Art Dispersants Used were the Following Dispersants C1 to C3:
C1: Disperbyk® 2010 from BYK-Chemie GmbH
C2: EFKA® 4585 from CIBA AG
C3: TEGO Dispers® 750 W from Evonik Industries AG

The pigment pastes were prepared as for Table 3, the amount of dispersing additive and water being adapted so that C1 and C3 were aqueous solutions with a strength of approximately 40% by weight, and C2 was an aqueous solution with a strength of approximately 50% by weight.

TABLE 4
White tint with Printex ® 95 pigment paste:

| Dispersing | Lightness | | | Rub-out | | |
|---|---|---|---|---|---|---|
| additive | L* | a* | b* | ΔE | Y | F |
| Example 1 | 54.03 | −1.08 | −4.59 | 1.51 | 22.00 | 138.24 |
| Example 2 | 46.91 | −0.94 | −3.93 | 1.12 | 15.95 | 221.44 |
| Example 3 | 45.11 | −0.85 | −3.46 | 1.19 | 14.62 | 249.30 |
| Example 4 | 51.03 | −1.05 | −4.69 | 0.98 | 19.29 | 168.79 |
| C1 | 47.32 | −0.91 | −3.36 | 1.07 | 16.26 | 215.54 |
| C2 | 45.37 | −0.84 | −3.24 | 1.43 | 14.81 | 245.06 |
| C3 | 46.49 | −0.93 | −3.93 | 1.13 | 15.63 | 227.64 |

It is evident that the polymer from Example 3 in particular exhibits improved color strength relative to the dispersing additives of the prior art.

TABLE 5
White tint with Heliogenblau ® 7101F pigment paste:

| Dispersing | Lightness | | | Rub-out | | |
|---|---|---|---|---|---|---|
| additive | L* | a* | b* | ΔE | Y | F |
| Example 1 | 63.25 | −20.91 | −35.66 | 0.27 | 31.89 | 72.74 |
| Example 2 | 62.99 | −21.33 | −36.34 | 0.88 | 31.57 | 74.14 |
| Example 3 | 61.28 | −21.15 | −37.28 | 0.80 | 29.57 | 83.88 |
| Example 4 | 63.91 | −20.61 | −34.28 | 0.56 | 32.69 | 69.29 |
| C1 | 62.33 | −21.34 | −36.89 | 1.23 | 30.79 | 77.79 |
| C2 | 62.53 | −21.62 | −36.74 | 1.23 | 31.03 | 76.67 |
| C3 | 61.45 | −21.26 | −37.00 | 0.50 | 29.76 | 82.87 |

In the table above it is clear that the inventive examples exhibit lower rub-out values and allow the preparation of phthalocyanine pastes with high stability. In the tinting shown, paints with high color strength F result, particularly in Example 3.

TABLE 6
White tint with Bayferrox ® 3920 pigment paste:

| Dispersing | Lightness | | | Rub-out | | |
|---|---|---|---|---|---|---|
| additive | L* | a* | b* | ΔE | Y | F |
| Example 1 | 84.65 | 6.90 | 26.52 | 0.21 | 65.32 | 9.20 |
| Example 2 | 84.36 | 7.06 | 27.50 | 0.61 | 64.76 | 9.59 |
| Example 3 | 81.56 | 8.41 | 30.32 | 0.91 | 59.49 | 13.79 |
| Example 4 | 85.01 | 6.73 | 26.09 | 1.09 | 66.03 | 8.74 |
| C1 | 82.45 | 7.89 | 30.84 | 1.76 | 61.13 | 12.36 |
| C2 | 82.85 | 7.72 | 30.23 | 1.46 | 61.88 | 11.74 |
| C3 | 85.17 | 6.41 | 27.66 | 3.00 | 66.34 | 8.54 |

The performance capacity of the inventive dispersants for finely divided pigments of the Bayferrox® type is emphasized in Table 6 by the lower rub-out values.

TABLE 7
White tint with Bayferrox ® 120 M pigment paste:

| Dispersing | Lightness | | | Rub-out | | |
|---|---|---|---|---|---|---|
| additive | L* | a* | b* | ΔE | Y | F |
| Example 3 | 63.94 | 21.63 | 8.57 | 0.83 | 32.73 | 69.14 |
| Example 4 | 64.98 | 21.08 | 8.31 | 0.45 | 34.02 | 63.97 |
| C3 | 65.49 | 21.04 | 8.29 | 0.70 | 34.67 | 61.56 |

The performance capacity of the inventive dispersants for red pigments of the Bayferrox® type is clear in Table 7 through the higher color values relative to a dispersing additive (C3) according to the prior art.

1. A block copolymer of the formula E-[AB]-T, where E is an initiator fragment of a polymerization initiator which is capable of initiating an atom transfer radical polymerization, A and B are different polymer blocks, and T is a chain polymer termination group, characterized in that the polymer block A is built from monomers of the formula A1: 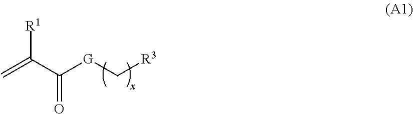
and the polymer block B is formed by a copolymer of monomers of the formula B1: 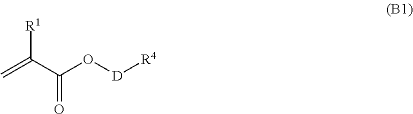
where D is a group of the general formula (C1)
—(C₂H₄O)ᵢ(C₃H₆O)ⱼ(C₄H₈O)ₖ(C₁₂H₂₄O)ₗ(C₈H₈O)ₘ— (C1)
where i, j, k, l, and m are mutually independent integers from 0-100, with the proviso that the sum of i+j+k+l+m≧1, and, if more than one of the indices i, j, k, l, and m is >0, the general formula (C1) represents a random oligomer, a block oligomer or a gradient oligomer,
and monomers of the formula B2: 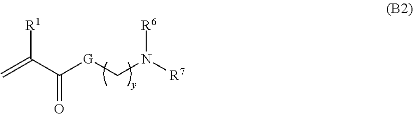
where R¹ independently at each occurrence is H or alkyl,
G=oxygen or NR², where R² independently at each occurrence is H or alkyl having 1 to 8 C atoms, preferably methyl, R³ is aryl or arylalkyl radical, R⁴ is alkyl, preferably C₁ to C₃ alkyl, R⁶ and R⁷ independently of one another are alkyl radicals, x=0 to 10 and y is 1 to 10.

2. The block copolymer of claim 1, characterized in that the polymer chain termination group is a sulfur-containing radical —SQ where Q is a monovalent organic radical.

3. The block copolymer of claim 1, characterized in that Q is an alkyl radical, an alcohol radical or an acid radical.

4. The block copolymer of claim 1, characterized in that the polymer block A has a number-average molecular weight of 500 g/mol to 100 000 g/mol.

5. The block copolymer of claim 1, characterized in that the polymer block B has a number-average molecular weight of 1000 g/mol to 500 000 g/mol.

6. The block copolymer of claim 1, characterized in that the block copolymer has a number-average molecular weight of 1500 g/mol to 500 000 g/mol.

7. The block copolymer of claim 1, characterized in that the block copolymer contains less than 5 ppm by mass of terminal halogens.

8. (canceled)

9. A process for preparing block copolymers as claimed in at least one of claims 1 to 8, characterized in that it comprises the steps of
A) reacting an atom transfer radical initiator, of the formula EX, having at least one organically bonded halogen atom X, with monomers of the formula A1 in the presence of at least one transition metal-containing catalyst, in a polymerization step,
B) reacting the compounds obtained in step A) with a polymer block B or with the compounds B1 and B2, and
C) adding a compound TH to the polymerization mixture from step B),
where A, B, B1, B2, and T are defined as described in any of the preceding claims.

10. The process as claimed in claim 9, characterized in that use is made as compound TH of thioglycolacetic acid, mercaptopropionic acid, mercaptoethanol, mercaptopropanol, mercaptobutanol, mercaptohexanol, octyl thioglycolate, methyl mercaptan, ethyl mercaptan, butyl mercaptan, dodecyl mercaptan, isooctyl mercaptan or tert-dodecyl mercaptan.

11. The process as claimed in claim 9, characterized in that use is made as initiator EX of p-toluenesulfonyl chloride, 2-chloro- or 2-bromopropionic acid, 2-chloro- or 2-bromoisobutyric acid, 1-phenethyl chloride or bromide, methyl or ethyl 2-bromo- or 2-chloropropionate, ethyl or methyl 2-chloro- or 2-bromoisobutyrate, chloro- or bromoacetonitrile, 2-chloro- or 2-bromopropionitrile, α-bromo-benzacetonitrile or α-bromo-γ-butyrolactone.

12. A method of dispersing a substance which comprises of adding the block copolymer of claim 1 to the substance.

13. A composition comprising a dispersant, characterized in that the dispersant is a block copolymer as claimed in claim 1.

14. The composition of claim 13, characterized in that the composition is composed of the dispersant and water.

15. The composition of claim 13, characterized in that the composition comprises at least one pigment.

16. The method of claim 12 wherein the block copolymer is added during the production of substance selected from the group consisting paints and varnishes from binder-containing or binder-free pigment pastes, coating materials, printing inks and print varnishes.

17. The block copolymer of claim 2, characterized in that:
Q is an alkyl radical, an alcohol radical or an acid radical;
the polymer block A has a number-average molecular weight of 500 g/mol to 100 000 g/mol;
the polymer block B has a number-average molecular weight of 1000 g/mol to 500 000 g/mol;
the block copolymer has a number-average molecular weight of 1500 g/mol to 500 000 g/mol; and
the block copolymer contains less than 5 ppm by mass of terminal halogens.
